(19) United States
(12) Patent Application Publication
(10) Pub. No.: US 2006/0218803 A1
(43) Pub. Date: Oct. 5, 2006

(54) Work table

(76) Inventor: Charlie Zhang, Oak Brook, IL (US)

Correspondence Address: Kevin D. Erickson;Pauley Petersen & Erickson, Suite 365, 2800 West Higgins Road, Hoffman Estates, IL, 60195, US

(21) Appl. No.: 11/098,296

(22) Filed: Apr. 4, 2005

(51) Int. Cl. B23D 51/02

(52) U.S. Cl. 30/371

(57) ABSTRACT

A work table having a tool movable in a cutting direction. The work table includes a support surface having a work area for supporting a work piece and forming a cutting channel through the work area in the cutting direction. A guide bar is mounted with respect to the work area and extends along the work area in the cutting direction. The guide bar has a length along which the tool moves, a width and a height, wherein the width is greater than the height. A tool base including a saddle is positionable with respect to the guide bar and slidably movable along the guide bar with respect to the cutting channel. The tool is mountable on the tool base and has a blade aligned with the cutting channel.

### BACKGROUND OF THE INVENTION

1. Field of the Invention

This invention relates generally to a work table and, more particularly, to a work table including a guide bar that is pivotally mounted with respect to a work area of the work table.

2. Description of Related Art

Conventional work tables typically include a tool, such as a circular saw or wet saw, mounted with respect to a surface of the work table. Many conventional work tables further include pipes that are positioned on opposing sides of the tool to provide a guide for cutting a work piece along a generally straight cut line. A collar attaches or mounts the tool to each of the pipes to allow the tool to move in a direction parallel to a length of the pipes.

Although generally providing a guide for cutting the work piece along a straight cut line, there are several problems and/or shortcomings associated with these conventional guide elements. For example, as a tool moves along the worktable surface with respect to the work piece, one collar may lock on a portion of the corresponding pipe while the other collar continues to move freely along the other corresponding pipe. As a result, the tool becomes misaligned with the cutting direction and cuts the work piece along a line diverging from the cut line.

### SUMMARY OF THE INVENTION

It is one object of this invention to provide an improved work table having a support surface for supporting a work piece, such as a wood, metal, stone or tile work piece.

It is another object of this invention to provide a work table having a tool base that is slidably movable along a length of a guide bar extending along the work table in a cutting direction for accurately cutting the work piece.

It is yet another object of this invention to provide a work table including a guide bar that is pivotally mounted with respect to the work area for accurately cutting the work piece at a desired cutting angle.

The above and other objects of the invention can be attained through a work table that includes a planar support surface. The support surface has a work area for supporting a work piece and forms a cutting channel through or along the work area in a cutting direction. A guide bar is mountable with respect to the work area and extends along a length of the work area in the cutting direction. The guide bar preferably has a width that is greater than a height of the guide bar. Preferably, but not necessarily, the guide bar includes at least one guide element extending along the work area in the cutting direction.

The work table also includes a tool base having a saddle that is mountable or positionable with respect to the guide bar. The tool base is slidably movable along the guide bar with respect to the cutting channel. Preferably, the saddle includes a follower element that cooperates with the corresponding guide element as the saddle moves along the guide bar. A tool, such as a circular saw, wet saw or any suitable tool known to those skilled in the art, is positionable and/or mountable on the tool base. The tool preferably includes a blade that is aligned with the cutting channel and partially extends into the cutting channel.

In one preferred embodiment of this invention, a first swing bracket is pivotally mounted with respect to an end portion of the work table and a second swing bracket, preferably the same or similar to the first swing bracket, is pivotally mounted with respect to an opposing end portion of the work table. For example, the first swing bracket may be pivotally attached or mounted to a first end portion of the support surface and the second swing bracket may be pivotally attached or mounted to an opposing second end portion of the support surface. The guide bar is fixedly mounted to each of the first swing bracket and the second swing bracket and pivotable with respect to the work area. Preferably, the first swing bracket pivots with respect to a support bracket fixed at the first end portion. The first swing bracket forms an arcuate shaped slot, and a pin extends through the slot and an aperture formed in the support bracket. The pin is threadedly connectable to a nut to lock the guide bar at a cutting angle with respect to the work area. The second swing bracket is similarly pivotally mounted with respect to a support bracket fixed at the second end portion. Preferably, the first swing bracket and/or the second swing bracket includes a gauge for measuring the cutting angle.

The invention still further comprehends a work table having a generally planar work area. The work table includes a cutting channel formed through the work area in a cutting direction. A guide bar is mounted with respect to the work area, and includes two parallel guide elements extending along the work area in the cutting direction. The guide bar has a first end portion fixedly mounted to a first swing bracket that is pivotally attached with respect to a first end portion of the support surface. At an opposing second end portion of the support surface, a second end portion of the guide bar is fixedly mounted to a second swing bracket is pivotally attached with respect to the support surface. A tool base is mountable with respect to the guide bar. The tool base includes a saddle positionable or mountable on the guide bar, and slidably movable along the guide bar with respect to the cutting channel. The tool base includes a first follower element cooperating with the first guide element and a second follower element cooperating with the second guide element. A power tool, such as a circular saw, is mountable on the tool base and slidable along a length of each of the two parallel guide elements so that a blade of the saw extends into the cutting channel as the saw slides along the length of the guide bar.

Other objects and advantages of this invention are apparent to those skilled in the art, in view of the following detailed description taken in conjunction with the appended claims and drawings.

### BRIEF DESCRIPTION OF THE DRAWINGS

FIG. 1 is a perspective view of a work table including a power tool mounted on a tool base of the work table, according to one preferred embodiment of this invention;

FIG. 2 is a front view of a work table including a power tool mounted on a tool base of the work table, according to one preferred embodiment of this invention;

FIG. 3 is a front view of a work table having a guide bar positioned at a cutting angle with respect to a work area of the work table, according to one preferred embodiment of this invention; and

FIG. 4 is a partial sectional view of a work table including a power tool mounted on a tool base of the work table, according to one preferred embodiment of this invention.

### DETAILED DESCRIPTION OF THE INVENTION

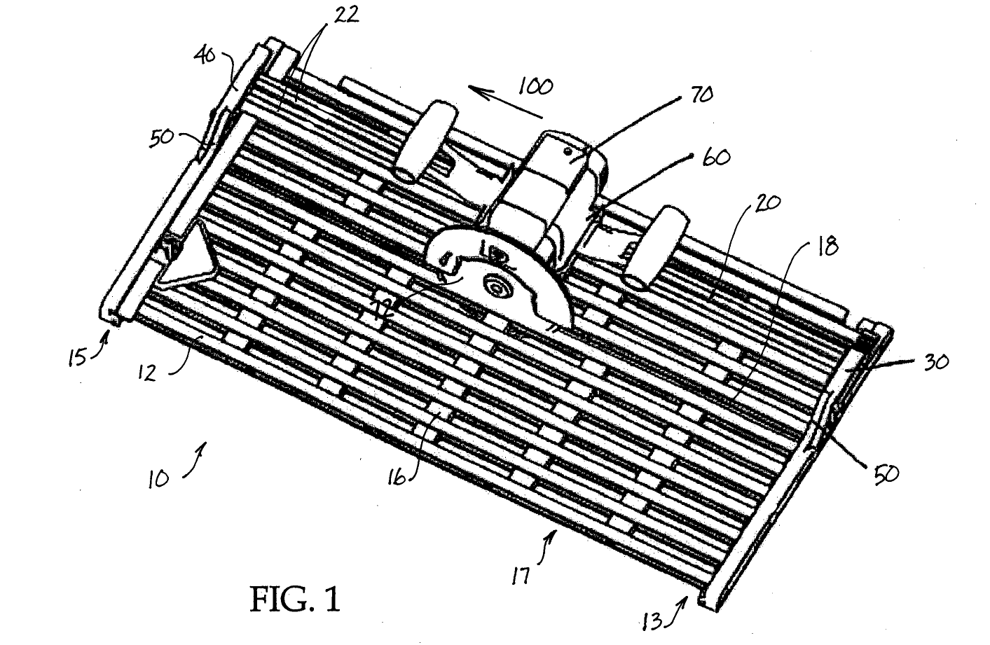

The present invention provides a work table 10 that includes a planar support surface 12 having a first or front end portion 13 and a second or back end portion 15. Support surface 12 forms a work area 16. Work area 16 provides support for a work piece, such as a wood, metal, stone or tile work piece. Support surface 12 includes or forms a cutting channel 18 along work area 16 in a longitudinal or cutting direction, as indicated by arrow 100 in FIG. 1. Preferably, but not necessarily, cutting channel 18 in the cutting direction is generally perpendicular to first end portion 13 and second end portion 15 of support surface 12. In one preferred embodiment of this invention, support surface 12 includes a lattice configuration, as shown in FIG. 1 for example. Support surface 12 is preferably made of a suitable lightweight and strong metal, alloy, wood or composite material, such as an aluminum material.

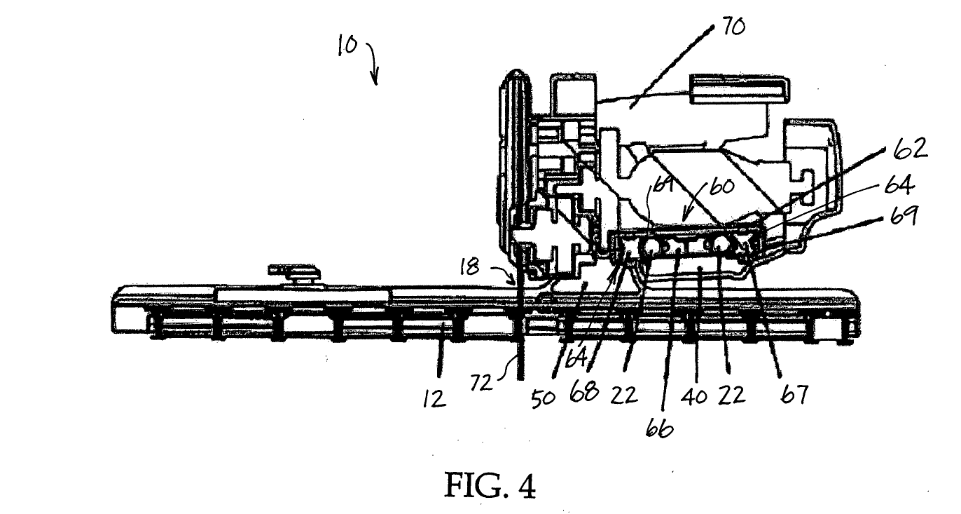

Referring further to FIG. 1, a guide bar 20 is mounted with respect to work area 16 and extends along a length of work area 16 in the cutting direction. Guide bar 20 preferably has a width that is greater than a height of guide bar 20. As shown in FIG. 4, work table 10 includes a tool base 60 having a saddle 62 that is positionable with respect to guide bar 20. Tool base 60 is slidably movable along a length of guide bar 20 with respect to cutting channel 18. A tool 70, such a circular saw or wet saw, is positionable on tool base 60 and has a blade 72 that is aligned with cutting channel 18. Preferably, but not necessarily, at least a portion of blade 72 extends at least partially into cutting channel 18. As tool base 60 is slidably moved along the length of guide bar 20, the rotating blade 72 of tool 70 cuts into and/or through a work piece positioned on work area 16 at a desired or measured location on the work piece and at a desired cutting angle.

In one preferred embodiment of this invention, a guide element 22 is connected to, integrated with or formed by guide bar 20. Preferably, guide element 22 extends along the length of guide bar 20 in the cutting direction and with respect to work area 16. Guide element 22 may include at least one edge, groove, indentation, shaft, platform, projection, rib, pipe and/or tongue, or any other element known to those skilled in the art suitable for guiding tool base 60 as tool base 60 moves along the length of guide bar 20. Guide element 22 may have any suitable or desired shape, dimensions and/or size.

Tool base 60 preferably includes a follower element 64 cooperating with guide element 22 as tool base 60 moves along the length of guide bar 20. In one preferred embodiment of this invention, saddle 62 may include at least one follower element 64, such as at least one roller, wheel, bearing, edge, groove, indentation, shaft, platform, projection, rib, pipe and/or tongue, that cooperates with corresponding guide element 22 as tool base 60 moves along the length of guide bar 20. For example, saddle 62 may include a first follower element 64 cooperating with a first guide element 22 and a second follower element 64 cooperating with a second guide element 22 as saddle 62 moves along guide bar 20. Additionally, saddle 62 may include a spacer element 66 positionable between first guide element 22 and second guide element 22 with saddle 62 positioned over guide bar 20.

As shown in FIG. 4, in one preferred embodiment of this invention, saddle 62 includes a first roller element 67 that cooperates with a corresponding parallel guide element 22 and a second roller element 68 that cooperates with the other corresponding parallel guide element 22, as saddle 62 moves or translates along guide bar 20. Preferably, but not necessarily, each roller element 67 and 68 has a rolling surface 69 that corresponds to an outer surface or periphery of cooperating guide element 22. Roller elements 67 and 68 may include any suitable roller element, such as a roller, wheel or bearing that allows and/or assists in saddle 62 moving or translating along a length of parallel guide elements 22. Spacer element 66 is positionable between parallel guide elements with saddle 62 positioned over guide bar 20, as shown in FIG. 4. Preferably, spacer element 66 has an outer surface that corresponds to a corresponding outer surface or periphery of each guide element 22. Spacer element 66 maintains saddle 62 properly positioned over guide bar 20 and prevents undesirable movement of tool 70 with respect to the work piece as tool base 60 moves along guide bar 20.

Alternatively or additionally, tool base 60 may include a guide element 22 that cooperates with the guide bar and/or a follower element 64 positioned on guide bar 20 as tool base 60 moves along guide bar 20.

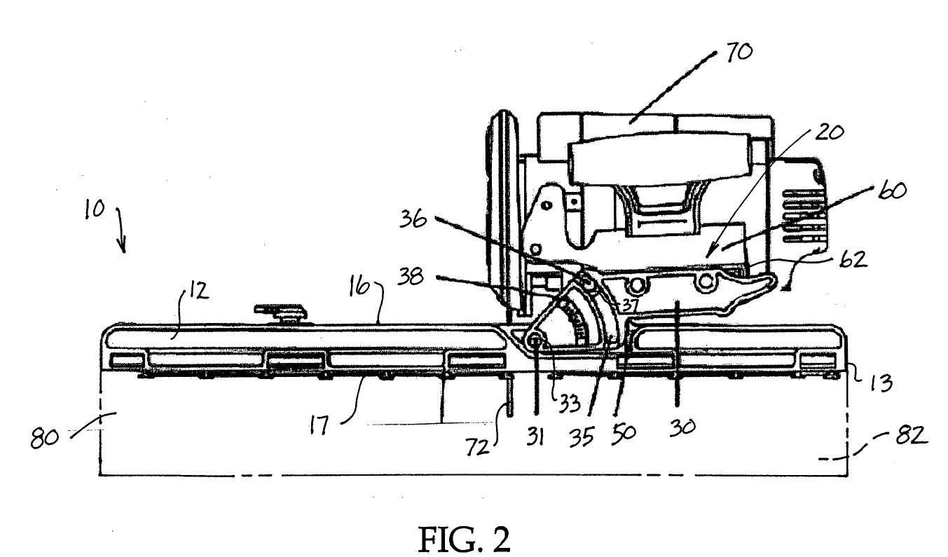

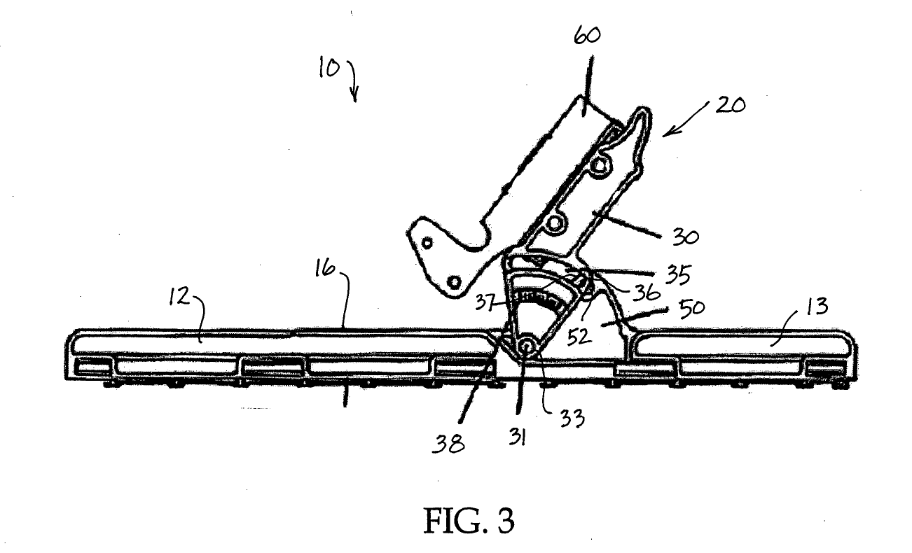

In one preferred embodiment of this invention, guide bar 20 is pivotable with respect to work area 16. As shown in FIGS. 2 and 3, guide bar 20 is fixedly mounted at a first end portion to a first swing bracket 30 and an opposing second swing bracket 40 at a second end portion. Preferably, first swing bracket 30 is pivotally attached or connected with respect to first end portion 13 of support surface 12 and a second swing bracket 40 is pivotally attached or connected with respect to opposing second end portion 15 of support surface 12. For example, as shown in FIGS. 2 and 3, first swing bracket 30 may be pivotally mounted or connected to first end portion 13 with a suitable mounting element, such as a pin 31 that extends through an aperture 33 formed in first swing bracket 30 and into support surface 12. Preferably, second swing bracket 40 is similarly pivotally mounted at second end portion 15 to support surface 12 using a pin that extends through an aperture formed in second swing bracket 40 and into support surface 12.

Referring further to FIG. 3, in one preferred embodiment of this invention, first swing bracket 30 is pivotally connected to and pivotable with respect to a support bracket 50 fixed at first end portion 13. Support bracket 50 may be an independent element that is mountable to work table 10 using suitable connectors, such as screws, bolts and/or a weld, or support bracket 50 may be integrated with work table 10, for example with first end portion 13. First swing bracket 30 forms an arcuate shaped slot 35, as shown in FIGS. 2 and 3. A pin 36 extends through slot 35 and an aperture 52 formed in support bracket 50. Pin 36 is threadedly engageable with a nut 37 to lock guide bar 20 at a desired cutting angle with respect to work area 16. It is apparent to those skilled in the art that any suitable connector can be used to position and lock guide bar 20 at a desired cutting angle with respect to work area 16. Preferably, first swing bracket 30 and/or second swing bracket 40 includes a gauge 38 for measuring the cutting angle.

In this preferred embodiment of the invention, second swing bracket 40 is also pivotally connected to and pivotable with respect to a second support bracket 50 fixed at second end portion 15. Second swing bracket 40 preferably forms an arcuate shaped slot and a pin extends through the slot and an aperture formed in second support bracket 50. The pin is threadedly engageable with a nut to secure and maintain guide bar 20 locked at the desired cutting angle with respect to work area 16 along the length of guide bar 20.

Work table 10 may also include a water tray 80 connected with respect to a bottom surface 17 of support surface 12, as shown in FIG. 2. Water tray 80 defines or forms a reservoir 82 for containing water or any suitable fluid for cooling blade 72 as blade 72 cuts through the work piece. Preferably, cutting channel 18 is in fluid communication with reservoir 82 so that as blade 72 rotates through cutting channel 18 to cut through the work piece, at least a portion of blade 72 extends into the water or cooling fluid contained within reservoir 82 to cool blade 72.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A work table having a tool movable in a cutting direction, the work table comprising:
a support surface having a work area for supporting a work piece and forming a cutting channel through the work area in the cutting direction;
a guide bar mounted with respect to the work area and extending along the work area in the cutting direction, the guide bar having a length along which the tool moves, a width and a height, the width greater than the height; and
a tool base including a saddle positionable with respect to the guide bar, the tool base slidably movable along the guide bar with respect to the cutting channel, the tool mountable on the tool base and having a blade aligned with the cutting channel.

2. The work table of claim 1 wherein the guide bar comprises a guide element extending along the length of the guide bar.

3. The work table of claim 2 wherein the guide element comprises at least one edge, groove, indentation, shaft, platform, projection, rib, pipe, tongue and combinations thereof.

4. The work table of claim 3 wherein the tool base comprises a follower element cooperating with the guide element as the tool base moves along the length of the guide bar.

5. The work table of claim 4 wherein the follower element comprises at least one roller, wheel, bearing, edge, groove, indentation, shaft, platform, projection, rib, pipe, tongue and combinations thereof.

6. The work table of claim 1 wherein the tool base comprises a guide element cooperating with the guide bar as the tool base moves along the guide bar.

7. The work table of claim 1 wherein the saddle comprises a first follower element cooperating with a first guide element of the guide bar and a second follower element cooperating with a second guide element of the guide bar as the saddle moves along the guide bar.

8. The work table of claim 7 wherein the saddle comprises a spacer element positionable between the first guide element and the second guide element with the saddle positioned over the guide bar.

9. The work table of claim 1 wherein the guide bar is pivotable with respect to the work area.

10. The work table of claim 1 wherein the guide bar is fixedly mounted to a first swing bracket pivotally attached with respect to a first end portion of the support surface and a second swing bracket pivotally attached with respect to an opposing second end portion of the support surface.

11. The work table of claim 10 wherein the first swing bracket pivots with respect to a support bracket fixed at the first end portion, the first swing bracket forming an arcuate shaped slot, and a pin extending through the slot and an aperture formed in the support bracket, the pin threadedly connectable to a nut to lock the guide bar at a cutting angle with respect to the work area.

12. The work table of claim 11 wherein the first swing bracket comprises a gauge for measuring the cutting angle.

13. The work table of claim 1 wherein the blade extends at least partially into the cutting channel.

14. The work table of claim 1 further comprising:
a water tray connected with respect to the support surface, the water tray forming a reservoir.

15. The work table of claim 14 wherein the cutting channel is in fluid communication with the reservoir.

16. A work table including a tool movable through a work area in a cutting direction, the work table comprising:
a support surface having a work area for supporting a work piece and forming a cutting channel along the work area in the cutting direction;
a guide bar pivotally mounted with respect to the work area and extending along the work area in the cutting direction, the guide bar having a length along which the tool moves, a width and a height, the width greater than the height, a first end portion of the guide bar fixedly mounted to a first swing bracket pivotally attached with respect to a first end portion of the support surface and a second end portion of the guide bar fixedly mounted to a second swing bracket pivotally attached with respect to an opposing second end portion of the support surface; and
a tool base including a saddle positionable with respect to the guide bar, the tool base slidably movable along the guide bar with respect to the cutting channel, the tool positionable on the tool base and having a blade aligned with the cutting channel.

17. The work table of claim 16 wherein the guide bar comprises at least one guide element extending along the length of the guide bar, wherein a follower element of the tool base cooperates with the at least one guide element as the tool base moves along the length of the guide bar.

18. The work table of claim 16 wherein the tool base comprises at least one guide element cooperating with the guide bar as the tool base moves along the length of the guide bar.

19. The work table of claim 16 wherein the first swing bracket pivots with respect to a support bracket fixed at the first end portion, the first swing bracket forming an arcuate shaped slot, and a pin extending through the slot and an aperture formed in the support bracket, the pin threadedly connectable to a nut to lock the guide bar at a cutting angle with respect to the work area.

20. A work table having a generally planar work area and including a power tool movable through the work area in a cutting direction, the work table comprising:
a cutting channel formed through the work area in the cutting direction;
a guide bar pivotally mounted with respect to the work area, and including two parallel guide elements extending along the work area in the cutting direction, the guide bar fixedly mounted to a first swing bracket pivotally attached with respect to a first end portion of the work table and a second swing bracket pivotally attached with respect to an opposing second end portion of the work table;
a tool base including a saddle slidably movable along the guide bar with respect to the cutting channel, the tool base including a first follower element cooperating with one guide element of the two parallel guide elements and a second follower element cooperating with another guide element of the two parallel guide elements as the saddle moves along the guide bar; and
the power tool mountable on the tool base and having a blade extending into the cutting channel as the power tool moves with respect to the guide bar.
